(19) United States
(12) Patent Application Publication
(10) Pub. No.: US 2026/0241806 A1
(43) Pub. Date: Aug. 20, 2026

(54) Electrical Compartment, Battery Pack, and Vehicle

(71) Applicant: EVE ENERGY CO., LTD., Huizhou (CN)

(72) Inventors: Shifan FENG, Huizhou (CN); Zhaofa HUANG, Huizhou (CN); Deqiang HUANG, Huizhou (CN)

(73) Assignee: EVE ENERGY CO., LTD., Huizhou (CN)

(21) Appl. No.: 19/346,128

(22) Filed: Sep. 30, 2025

(30) Foreign Application Priority Data
Feb. 17, 2025 (CN) 202510175165.0
Feb. 17, 2025 (CN) 202520252676.3
Apr. 30, 2025 (WO) PCT/CN2025/092366

(51) Int. Cl. B60L 50/64; H01M 10/42; H01M 50/298

(52) U.S. Cl. CPC B60L 50/64; H01M 10/425; H01M 50/298; H01M 2010/4271; H01M 2200/103; H01M 2220/20

(57) ABSTRACT

An electrical compartment, a battery pack, and a vehicle are provided. The electrical compartment includes an electrical compartment body and a BMS assembly installed in the electrical compartment body. The BMS assembly is used to connect to a battery module. The BMS assembly includes a first BMS unit and a second BMS unit arranged along a height direction of the electrical compartment body. This configuration reduces the space occupied by multiple BMSs in a width direction of the electrical compartment.

### CROSS-REFERENCE TO RELATED APPLICATION(S)

The application claims priorities to and the benefit of PCT Patent Application No. PCT/CN2025/092366 having International filing date of April 30, 2025, Chinese Patent Application No. 202510175165.0, filed with the China National Intellectual Property Administration on February 17, 2025, and Chinese Patent Application No. 202520252676.3, filed with the China National Intellectual Property Administration on February 17, 2025, the entire contents of which are incorporated herein by reference

### TECHNICAL FIELD

The present application relates to the field of battery technology, and more particularly, to an electrical compartment, a battery pack, and a vehicle.

### DESCRIPTION OF RELATED ART

A battery pack is one of the core components of a vehicle, providing the electrical energy required to power the vehicle’s electric motor, thereby driving the vehicle. To enhance driving range, battery packs with high capacity, high voltage, and high current are commonly employed, leading to a large number of battery cells arranged in series or parallel within the battery pack.

The electrical compartment of a battery pack typically houses various electrical components configured to manage and control the operation of battery modules. In related art, when multiple Battery Management Systems (BMSs) are included in the electrical compartment, they are generally arranged along the width direction of the electrical compartment.

### SUMMARY OF INVENTION

However, such an arrangement causes the multiple BMSs to occupy significant space in the width direction of the electrical compartment.

The present application provides an electrical compartment. The electrical compartment includes: an electrical compartment body; and a battery management system (BMS) assembly installed within the electrical compartment body and configured to connect to a battery module, the BMS assembly including a first BMS unit and a second BMS unit, wherein the first BMS unit and the second BMS unit are arranged along a height direction of the electrical compartment body.

The present application further provides a battery pack for a vehicle, including the aforementioned electrical compartment body and a battery module. The battery module is installed within a battery compartment body, the electrical compartment body is connected to the battery compartment body, and the battery compartment body and the electrical compartment body are arranged along a length direction of the battery pack.

The present application also provides a vehicle including the aforementioned electrical compartment or the aforementioned battery pack.

### Beneficial Effects

In the electrical compartment provided by the present application, the BMS assembly includes a first BMS unit and a second BMS unit arranged along the height direction of the electrical compartment body. Compared to the related art, where BMS assemblies are arranged along the width direction of the electrical compartment, the first and second BMS assemblies in embodiments of the present application occupy less space in the width direction of the electrical compartment body.

In the battery pack provided by the present application, the first and second BMS assemblies occupy less space in the width direction of the vehicle, thereby reducing the overall space occupied by the battery pack in the vehicle’s width direction. Since the battery module is installed in the battery compartment body and the BMS assembly is installed in the electrical compartment body, the BMS assembly and the battery module are arranged along the length direction of the vehicle. This configuration effectively utilizes the height and length directions of the vehicle, resulting in a more compact battery pack structure.

In the vehicle provided by the present application, the first and second BMS assemblies occupy less space in the width direction, reducing the overall space occupied by the battery pack in the vehicle’s width direction. The arrangement of the BMS assembly and battery module along the vehicle’s length direction, with the battery module installed in the battery compartment body and the BMS assembly in the electrical compartment body, leverages the vehicle’s height and length directions, achieving a more compact battery pack structure.

### BRIEF DESCRIPTION OF DRAWINGS

FIG. 1 is a top view of a battery pack according to a possible implementation of the present application.

FIG. 2 is a cross-sectional view along line A-A in FIG. 1.

FIG. 3 is a partial enlarged view at location B in FIG. 2.

FIG. 4 is a top view of a partial structure of a battery pack according to a first possible implementation of the present application.

FIG. 5 is a partial enlarged view at location C in FIG. 4.

FIG. 6 is a top view of a partial structure of the battery pack according to a second possible implementation of the present application.

FIG. 7 is a cross-sectional view along line D-D in FIG. 6.

FIG. 8 is a schematic view of a partial structure of an electrical compartment body in FIG. 1.

FIG. 9 is a schematic view of a partial structure of the battery pack according to a third possible implementation of the present application.

FIG. 10 is a partial enlarged view at E in FIG. 9.

FIG. 11 is a schematic view of a partial structure of the battery pack according to a fourth possible implementation of the present application.

FIG. 12 is a partial enlarged view at F in FIG. 11.

FIG. 13 is a schematic view of a partial structure of the battery pack according to a fifth possible implementation of the present application.

FIG. 14 is a partial enlarged view at location G in FIG. 13.

FIG. 15 is a circuit diagram of the battery pack according to a possible implementation of the present application.

FIG. 16 is a block diagram of a vehicle according to a possible implementation of the present application.

### DESCRIPTION OF REFERENCE NUMERALS

10: Battery pack; 100: Housing assembly; 101: Housing; 102: Battery compartment cover; 103: Crossbeam; 105: Middle housing; 109: Mounting housing; 110: Battery compartment body; 1101: Second bottom wall; 111: First cavity; 113: Second cavity; 130: Electrical compartment body; 1301: First bottom wall; 1305: First mounting member; 1307: Electrical compartment cover; 1308: First sidewall; 200: Battery module; 210: First battery module; 230: Second battery module; 240: Third battery module; 250: Fourth battery module; 300: BMS assembly; 310: First BMS unit; 311: Second BMS; 313: First BMS; 314: Wiring portion; 330: Second BMS unit; 331: Third BMS; 333: Fourth BMS; 315: Shunt; 317: First fuse; 318: Pre-charge resistor; 3351: First positive relay; 3353: Pre-charge relay; 3355: First negative relay; 3357: Charging negative relay; 3359: Charging positive relay; 400: Second mounting member; 401: First mounting portion; 403: Second mounting portion; 405: Reinforcement portion; 810: First overcurrent assembly; 830: Second overcurrent assembly; 20: Vehicle; 30: Electrical compartment.

### DETAILED DESCRIPTION OF EMBODIMENTS OF THE INVENTION

A battery pack is a critical component of a vehicle, supplying electrical energy to the vehicle’s electric motor to drive the vehicle. To increase driving range, battery packs with high capacity, high voltage, and high current are commonly used, resulting in a large number of battery cells arranged in series or parallel.

The electrical compartment of a battery pack typically includes various electrical components configured to manage and control the operation of battery modules. In related art, when multiple battery management systems (BMSs) are included in the electrical compartment, they are typically arranged along the width direction of the electrical compartment, occupying significant space in that direction.

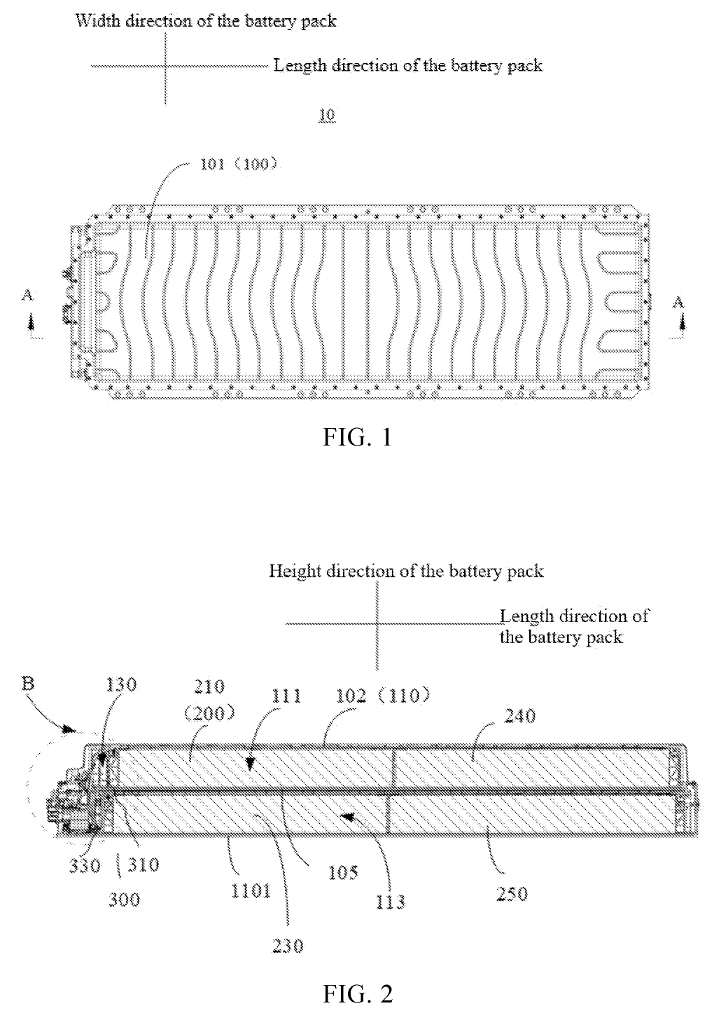

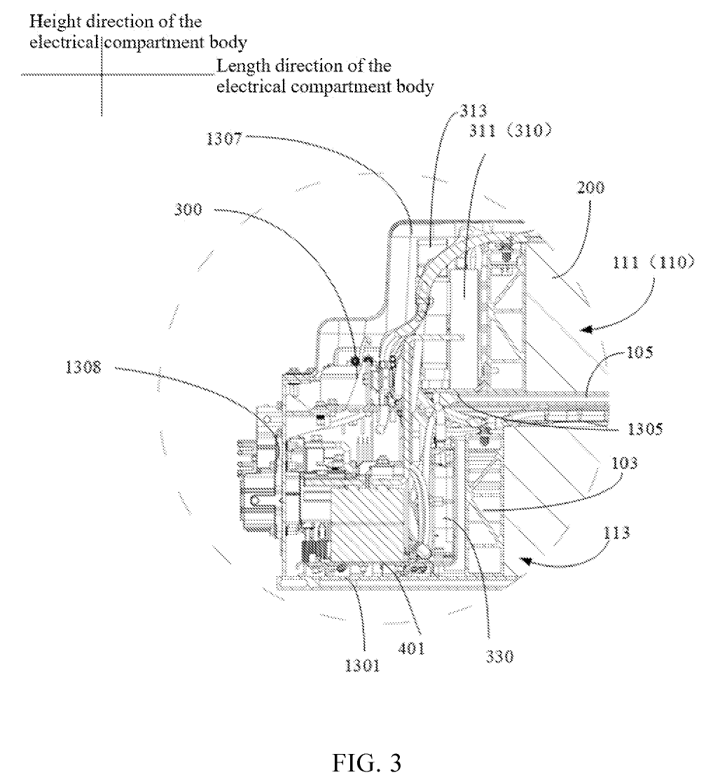

In a first aspect, as shown in FIG. 1, embodiments of the present application provide an electrical compartment 30 for a battery pack 10. As shown in FIG. 2, the electrical compartment 30 includes an electrical compartment body 130 and a BMS assembly 300 installed within the electrical compartment body 130. The BMS assembly 300 is configured to connect to a battery module 200 and includes a first BMS unit 310 and a second BMS unit 330, wherein the first BMS unit 310 and the second BMS unit 330 are arranged along a height direction of the electrical compartment body 130.

In embodiments of the present application, the BMS assembly 300 includes the first BMS unit 310 and the second BMS unit 330 arranged along the height direction of the electrical compartment body 130. Compared to the related art, where BMS assemblies are arranged along a width direction of the electrical compartment body 130, the first BMS unit 310 and the second BMS unit 330 occupy less space in the width direction of the electrical compartment body 130.

In some embodiments, the BMS assembly 300 is installed within the electrical compartment body 130 and configured to connect to the battery module 200 located outside the electrical compartment body 130. This arrangement prevents interference from the BMS assembly 300 with the battery module 200, facilitating separate maintenance and installation of the BMS assembly 300 and the battery module 200.

The battery module 200 and the BMS assembly 300 may be electrically connected, with the BMS assembly 300 configured to manage and control the battery module 200.

The battery module may comprise a plurality of battery cells connected in series or parallel, and may integrate connectors, protective circuits, temperature sensors, and the like to ensure safe and efficient energy transfer.

In some embodiments, when the electrical compartment is applied to a battery pack, the width, height, and length directions of the electrical compartment are aligned with those of the battery pack, ensuring that the first BMS unit 310 and the second BMS unit 330 occupy less space in the width direction of the battery pack 10. When the battery pack is applied to a vehicle, the width, height, and length directions of the vehicle are aligned with those of the battery pack, further ensuring that the first BMS unit 310 and the second BMS unit 330 occupy less space in the vehicle’s width direction.

The BMS assembly 300, as the battery management system of the battery pack, may perform one or more of the following functions. For example, in a first aspect, it may be configured to continuously collect state information, such as temperature, voltage, current, and other parameters, about each cell in the battery module, and accordingly evaluate the overall health of the battery module. In a second aspect, based on the collected data, the BMS may calculate key indicators such as State of Charge (SOC), State of Health (SOH), and State of Power (SOP). In a third aspect, it may prevent overcharging, over-discharging, and overheating of the battery; for example, upon detecting an abnormal situation, it may disconnect the circuit or issue alert signals to an external control system. In a fourth aspect, it may balance a power level between each cell by active or passive methods to extend the entire battery pack’s lifespan. In a fifth aspect, it may also be equipped with standardized communication protocols (e.g., CAN bus) to exchange data with other vehicle electronic systems. The BMS assembly 300 may include multiple BMS units, such as a third BMS 331, a fourth BMS 333, a second BMS 311, and a first BMS 313.

Please refer to FIG. 3, in some embodiments, the electrical compartment body 130 includes a first bottom wall 1301 and a first mounting member 1305 arranged opposite each other along the height direction of the electrical compartment body 130. The first BMS unit 310 is positioned on a side of the first mounting member 1305 facing away from the first bottom wall 1301, and the second BMS unit 330 is installed between the first bottom wall 1301 and the first mounting member 1305.

The first mounting member 1305 facilitates the installation of the first BMS unit 310. By positioning the first BMS unit 310 on the side of the first mounting member 1305 facing away from the first bottom wall 1301 and installing the second BMS unit 330 between the first bottom wall 1301 and the first mounting member 1305, the first BMS unit 310 and the second BMS unit 330 are arranged along the height direction of the electrical compartment body 130.

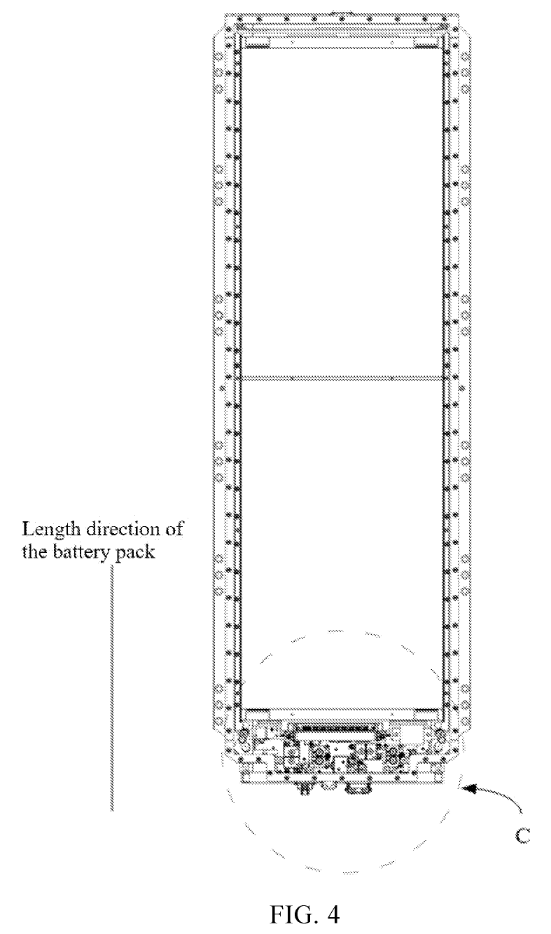

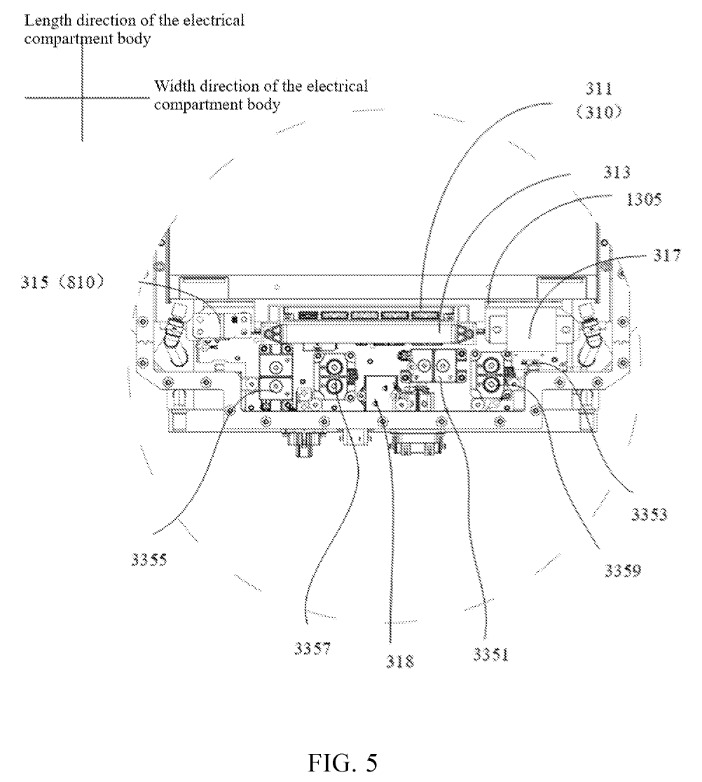

Referring to FIGS. 4 and 5, in some embodiments, the first BMS unit 310 includes a first BMS 313 and a second BMS 311 arranged along the length direction of the electrical compartment body 130. The first BMS 313 is electrically connected to the second BMS 311, and the second BMS 311 is configured to electrically connect to the battery module 200.

The first BMS 313 may serve as a master BMS, while the second BMS 311 may serve as a slave BMS. The second BMS 311 is configured to collect current and voltage data from multiple cells of the battery module 200. The first BMS 313 is configured to manage and control the second BMS 311, collect current and voltage data from electrical components within the electrical compartment body 130, and manage and control the operational states of these electrical components, thereby managing and controlling the operational states of the cells in the battery module 200.

In some embodiments, the electrical compartment further includes a plurality of electrical components housed within the electrical compartment body 130, such as a first overcurrent assembly 810 and a second overcurrent assembly 830.

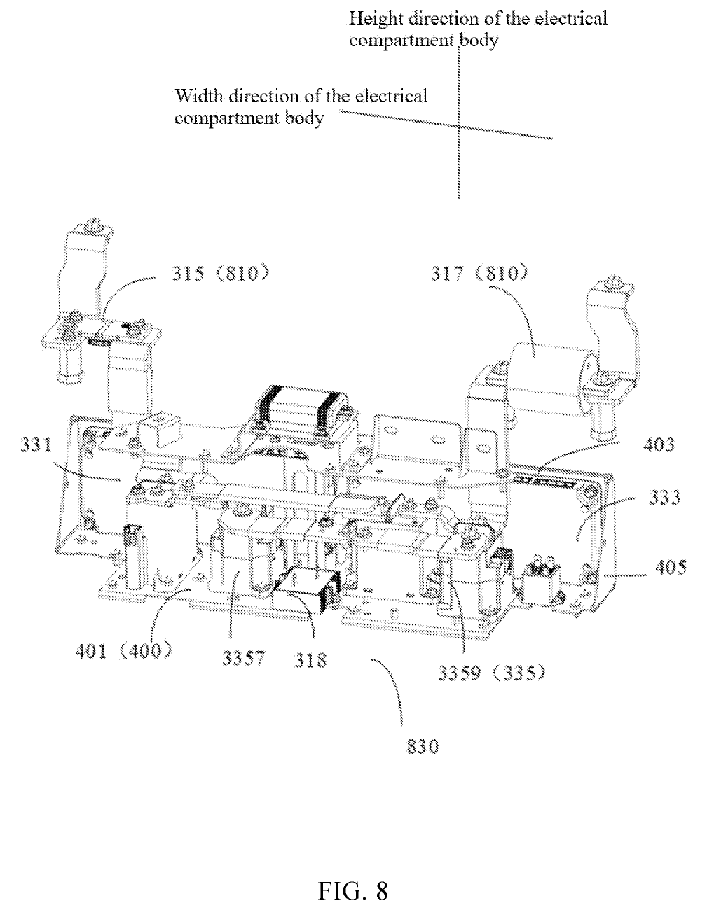

Please combine with FIGS. 7 and 8, the electrical compartment includes a first overcurrent assembly 810 configured to electrically connect to the battery module 200. The first overcurrent assembly 810 is installed on the side of the first mounting member 1305 facing away from the first bottom wall 1301. The first overcurrent assembly 810 is arranged along the width direction of the electrical compartment body 130 with respect to the first BMS unit 310.

In some embodiments, the first overcurrent assembly 810 includes a shunt 315 configured to electrically connect to the battery module 200 and arranged along the width direction of the electrical compartment body 130 with respect to the first BMS unit 310.

The shunt 315 is configured to monitor current changes during the charging and discharging of the battery module. Specifically, the shunt 315 diverts a small portion of the current to a measuring instrument to measure large currents. The shunt 315 is essentially a precision resistor with very low resistance, producing a small voltage drop proportional to the current when direct current flows through it. This voltage drop can be detected by a millivoltmeter or other measuring device connected across the shunt 315 and converted into a corresponding current reading. This design allows the shunt 315 to expand the measurement range of a current meter, as most current bypasses the meter through the shunt 315, preventing overload damage. The shunt 315 may be made of manganin, a material with a low temperature coefficient of resistance and high resistivity, ensuring stable resistance across different temperatures to improve measurement accuracy and reduce errors due to temperature variations.

In some embodiments, the first overcurrent assembly 810 further includes a first fuse 317. The first BMS unit 310 is positioned between the shunt 315 and the first fuse 317, and along the width direction of the electrical compartment body 130.

The first fuse 317 serves as a primary defense, protecting the battery module from short circuits and other abnormal current conditions. In the event of severe overcurrent or short-circuit conditions, the first fuse 317 rapidly interrupts the circuit to prevent safety risks such as fire or explosion. The main function of the first fuse 317 may be as follows: in the event of a high-multiple overcurrent or short-circuit situation in the high-voltage circuit, the first fuse 317 rapidly fuses, thereby immediately interrupting the fault current path and ensuring the safety of the battery module; the first fuse is also capable of coping with a prolonged and sustained overload condition. If the actual operating current of the system exceeds a set safety threshold, but has not yet reached a level sufficient to trigger an instantaneous fuse, the fuse can still provide a certain degree of protection; the first fuse 317 can work in concert with other types of protective devices (e.g., relays, pre-charged resistors, etc.), e.g., low-multiple overcurrent conditions can be managed by the BMS control relay; and in the face of a higher-multiple transient peak currents, the fuse can be relied upon for emergency disconnection.

In some embodiments, the electrical compartment body 130 further includes a second mounting member 400 located between the first bottom wall 1301 and the first mounting member 1305. The second mounting member 400 includes a first mounting portion 401 installed on the first bottom wall 1301 and arranged opposite thereto.

Please combine with FIG. 8, the electrical compartment further includes a second overcurrent assembly 830 installed on the side of the first mounting portion 401 facing away from the first bottom wall 1301. The second overcurrent assembly 830 is electrically connected to the first overcurrent assembly 810.

The second overcurrent assembly 830 is installed on the side of the first mounting portion 401 of the second mounting member 400 facing away from the first bottom wall 1301, while the first overcurrent assembly 810 is installed on the side of the first mounting member 1305 facing away from the first bottom wall 1301. The second mounting member 400 is positioned between the first bottom wall 1301 and the first mounting member 1305, thereby arranging the first overcurrent assembly 810 and the second overcurrent assembly 830 along the height direction of the electrical compartment body 130.

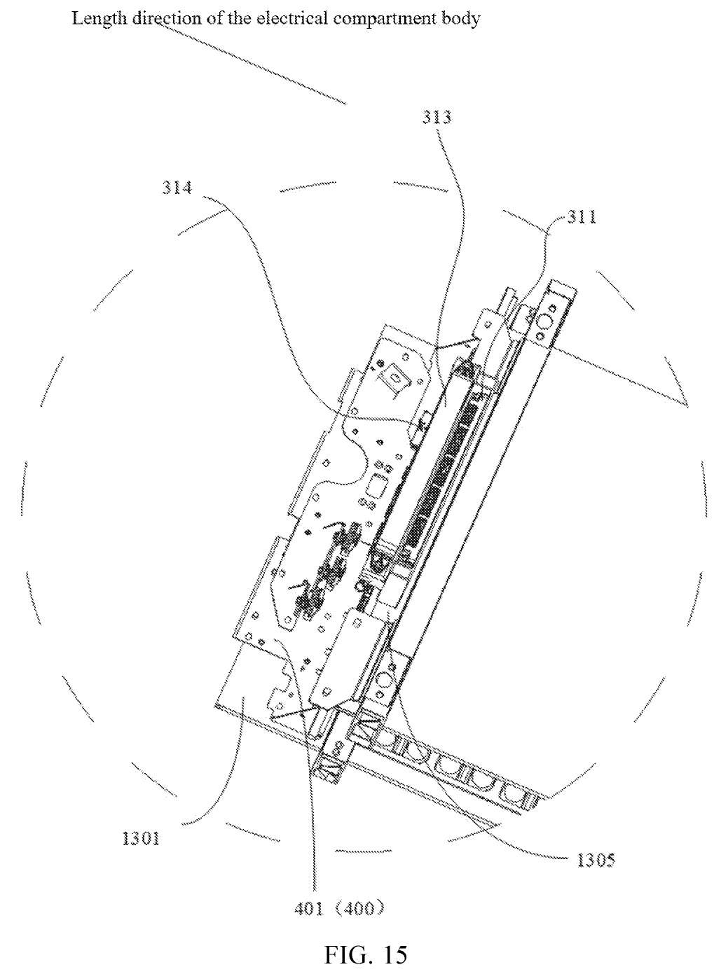

Please combine with FIGS. 10 and 15, in some embodiments, the second overcurrent assembly 830 includes a charging positive relay 3359 and a charging negative relay 3357. The charging positive relay 3359 is electrically connected to the first fuse 317, the charging negative relay 3357 is electrically connected to the shunt 315, and the charging positive relay 3359 and the charging negative relay 3357 are arranged along the width direction of the electrical compartment body 130.

The charging positive relay 3359 may be installed between the positive terminal of the battery module and the charging circuit. During charging, the charging positive relay 3359 closes to form a positive current path from the charging station to the battery module. When charging is complete or a fault is detected, it opens to interrupt the current, ensuring safety.

The charging negative relay 3357 may be installed on the negative terminal side of the battery module, working in conjunction with the charging positive relay 3359. The charging negative relay 3357 provides a complete circuit during charging and opens in non-charging states to prevent unnecessary current flow, avoiding potential safety hazards such as short circuits or overheating.

In some embodiments, the second overcurrent assembly 830 further includes a first positive relay 3351 and a first negative relay 3355. The first positive relay 3351 is electrically connected to the first fuse 317, and the first negative relay 3355 is electrically connected to the shunt 315. The first positive relay 3351 is positioned between the charging positive relay 3359 and the charging negative relay 3357, and the first negative relay 3355 is positioned on the side of the charging negative relay 3357 facing away from the charging positive relay 3359.

In some embodiments, the first positive relay 3351 is located on the positive terminal side of the battery module, controlling the positive current path from the battery module to the vehicle’s high-voltage electrical system. During normal operation, when the vehicle is started or requires power, the first positive relay 3351 closes, allowing current to flow to the motor controller and other high-voltage loads. In non-operational states, emergencies, or during maintenance, the first positive relay 3351 opens to ensure no current flows from the battery, protecting personnel and equipment.

The first negative relay 3355, located on the negative terminal side of the battery module, may be connected to the vehicle’s ground. It works in conjunction with the first positive relay 3351 to provide a complete current circuit. The first negative relay 3355 closes when needed to complete the circuit and opens to interrupt the circuit in non-powered states or faults, preventing short circuits or other electrical hazards.

In some embodiments, the second overcurrent assembly 830 further includes a pre-charge resistor 318 electrically connected to the first fuse 317 and positioned between the first positive relay 3351 and the charging negative relay 3357.

The pre-charge resistor 318 limits inrush current when the main relays between the battery module and the motor controller are closed. Due to the large capacitance of the capacitor bank in the motor controller being initially uncharged, a low-impedance path is formed, which can lead to very high transient currents (inrush current). The pre-charge resistor 318 effectively limits this initial current to a safe threshold, preventing damage to capacitors and other circuit components. The pre-charge resistor 318 also protects electronic components by gradually charging the capacitors in the motor controller, ensuring they function normally under sudden high voltages, thereby extending component lifespan and improving system reliability. Additionally, the pre-charge resistor 318 stabilizes the power supply voltage, enabling the motor controller and related circuits to reach operating voltage smoothly without abrupt changes, which is critical for maintaining the stability of the power drive system. The pre-charge resistor 318 may include monitoring mechanisms to ensure that the first positive relay and first negative relay close only after the capacitors are fully charged and the system is stable, directly connecting the battery to the motor controller and other loads.

In some embodiments, the second overcurrent assembly 830 further includes a pre-charge relay 3353 positioned on the side of the charging positive relay 3359 facing away from the charging negative relay 3357 and electrically connected to the pre-charge resistor 318.

In some embodiments, the pre-charge relay 3353 gradually establishes voltage. To be specific, during vehicle startup, the capacitor bank in the motor controller needs to be charged to the same voltage level as the power battery. When the pre-charge relay 3353 closes, it forms a current path through the pre-charge resistor 318, allowing the capacitors to charge gradually until their voltage approaches that of the power battery, preventing large current surges due to the capacitors’ initial low-voltage state. The pre-charge relay 3353 protects electronic components: by limiting initial inrush current, the pre-charge relay 3353 works in conjunction with the pre-charge resistor 318 to ensure the motor controller and other high-voltage components function normally under high current, thus extending component lifespan and improving system reliability. The pre-charge relay 3353 stabilizes the power system. The pre-charge process ensures stable startup of the power drive system without abrupt voltage changes, maintaining overall electrical system stability. The pre-charge relay 3353 supports safe operation by working with monitoring mechanisms in the control system, closing the first positive and negative relays only after the capacitors are fully charged and the system voltage is stable to connect the battery module to the motor controller and other loads, thereby avoiding risks from large currents. Additionally, the pre-charge relay 3353 helps reduce electromagnetic interference generated during startup by controlling the current to gradually increase rather than instantly reach its peak, which is crucial for maintaining the normal operation of other electronic devices in the vehicle.

Referring to FIG. 8, in some embodiments, the second mounting member 400 further includes a second mounting portion 403 connected via a bent connection to the first mounting portion 401. At least part of the second mounting portion 403 is located between the first mounting portion 401 and the first mounting member 1305. The second BMS unit 330 is installed on the side of the second mounting portion 403 near the second overcurrent assembly 830, and the second BMS unit 330 and the second overcurrent assembly 830 are arranged along the length direction of the electrical compartment body 130.

The second mounting portion 403 may be connected via a bent connection to the first mounting portion 401 at a 90-degree angle through welding, bonding, or integral molding.

The second BMS unit 330 is installed on the side of the second mounting portion 403 adjacent to the second overcurrent assembly 830, with the second BMS unit 330 and the second overcurrent assembly 830 arranged along the length direction of the electrical compartment body 130. The electrical components of the second overcurrent assembly 830, such as the charging positive relay 3359, the charging negative relay 3357, the first positive relay 3351, the first negative relay 3355, the pre-charge resistor 318, and the pre-charge relay 3353, are collectively arranged along the width direction of the electrical compartment body 130. This configuration ensures the second BMS unit 330 installed on the second mounting member 400 forms a compact structure with the second overcurrent assembly 830, with adequate electrical clearance between them.

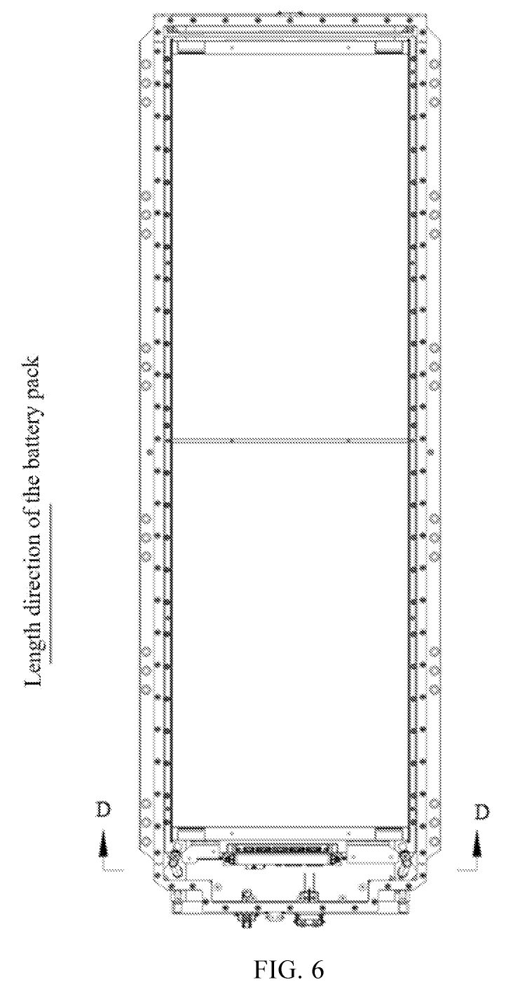

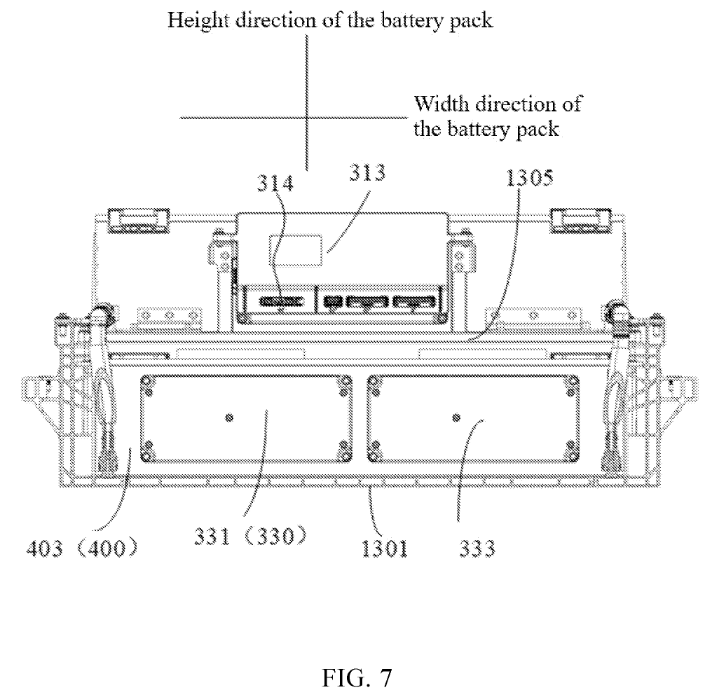

Please combine with FIGS. 6 and 7, in some embodiments, the second BMS unit 330 includes a third BMS 331 and a fourth BMS 333 arranged along the width direction of the electrical compartment body 130. This arrangement complements the second overcurrent assembly 830, also arranged along the width direction, effectively utilizing the spatial dimensions of the second mounting member 400 and providing adequate electrical clearance between the third BMS 331 and the fourth BMS 333.

The third BMS 331 and the fourth BMS 333 may be electrically connected to the first BMS 313.

The third BMS 331 and the fourth BMS 333 may serve as slave BMSs, working with the second BMS 311 to collect current and voltage data from multiple cells of the battery module 200. In the present application, one master BMS and three slave BMSs are configured to collect current and voltage data from the cells of the battery module 200. In other examples, two or four slave BMSs may be used, depending on the number of cells in the battery module.

The second BMS 311 is configured to electrically connect to the battery module 200 to collect current and voltage data from the cells of the battery module 200. The first BMS 313 is configured to manage and control the second BMS 311, collect current and voltage data from electrical components within the electrical compartment body 130, and manage and control their operational states, thereby managing and controlling the operational states of the cells in the battery module 200.

In some embodiments, the second mounting member 400 further includes a reinforcement portion 405, at least part of which is located between the first mounting portion 401 and the second mounting portion 403. The reinforcement portion 405 connects to both the first mounting portion 401 and the second mounting portion 403.

Since the second overcurrent assembly 830 is installed on the side of the first mounting portion 401 facing away from the first bottom wall 1301, and the first overcurrent assembly 810 is installed on the side of the first mounting member 1305 facing away from the first bottom wall 1301, the reinforcement portion 405 supports the first mounting portion 401 and the second mounting portion 403, enhancing the overall stability of the second mounting member 400.

Embodiments of the present application further provide a battery pack 10 for a vehicle. The vehicle may be a fuel vehicle, a plug-in hybrid vehicle, or a new energy vehicle, without specific limitation.

Please combine with FIGS. 1 and 2, in some embodiments, the battery pack 10 may include:

a battery compartment body 110 and a battery module 200 installed therein. The battery module 200 may comprise a plurality of battery cells connected in series or parallel, integrating connectors, protective circuits, temperature sensors, and the like to ensure safe and efficient energy transfer.

The battery pack 10 further includes an electrical compartment. The electrical compartment body 130 is connected to the battery compartment body 110, and the battery compartment body 110 and the electrical compartment body 130 arranged along the length direction of the battery pack 10.

Given the limited space in the width direction of a vehicle due to the presence of electrical equipment (e.g., engines, internal combustion engines), crossbeams, and longitudinal beams, the BMS assembly in embodiments of the present application includes a first BMS unit 310 and a second BMS unit 330 arranged along the height direction of the vehicle. Compared to the related art, where multiple BMSs are arranged along the vehicle’s width direction, the first BMS unit 310 and the second BMS unit 330 occupy less space in the vehicle’s width direction, reducing the overall space occupied by the battery pack. Since the battery module 200 is installed in the battery compartment body and the BMS assembly is installed in the electrical compartment body, the BMS assembly 300 and the battery module 200 are arranged along the vehicle’s length direction, effectively utilizing the vehicle’s height and length directions for a more compact battery pack structure.

In some embodiments, when the electrical compartment is applied to a battery pack, the width, height, and length directions of the electrical compartment are aligned with those of the battery pack, ensuring that the first BMS unit 310 and the second BMS unit 330 occupy less space in the battery pack’s width direction. When the battery pack is applied to a vehicle, the vehicle’s width, height, and length directions are aligned with those of the battery pack, further minimizing space occupation in the vehicle’s width direction.

In the present application, in a first aspect, the battery compartment body 110 and the electrical compartment body 130 are arranged along the length direction of the battery pack. Electrical components such as the first overcurrent assembly 810 and the second overcurrent assembly 830 are provided in the electrical compartment body 130 without crowding the space of the battery compartment body 110. This allows the battery compartment body 110 to have more space to accommodate larger battery modules 200, enabling a larger number of cells in series, a larger quantity of cells. This results in greater capacity, higher voltage, and higher current for the battery pack, thereby improving driving range.

In a second aspect, arranging the first BMS unit 310 and the second BMS unit 330 along the height direction of the electrical compartment body 130 creates a compact structure, reducing their occupation of the length direction of the electrical compartment body 130 and minimizing compression of the battery compartment body 110.

In a third aspect, arranging the first overcurrent assembly 810 and the second overcurrent assembly 830 along the height direction of the electrical compartment body 130 further reduces the occupation of the length direction of the electrical compartment body 130 by electrical components, minimizing compression of the battery compartment body 110.

In some examples, referring to FIGS. 1 and 2, the battery pack 10 may include a housing assembly 100, with the battery compartment body 110 and the electrical compartment body 130 being connected parts of the housing assembly 100. Referring to FIG. 2, the housing assembly 100 may include the connected battery compartment body 110 and electrical compartment body 130, with the battery module 200 installed in the battery compartment body 110 and the BMS assembly 300 installed in the electrical compartment body 130. This arrangement allows the BMS assembly 300 and the battery module 200 to be aligned along the vehicle’s length direction, with the first BMS unit 310 and the second BMS unit 330 arranged along the vehicle’s height direction, effectively utilizing the vehicle’s height and length directions for a compact battery pack structure.

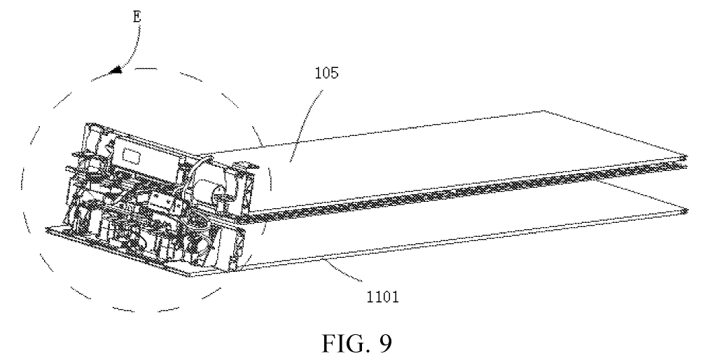

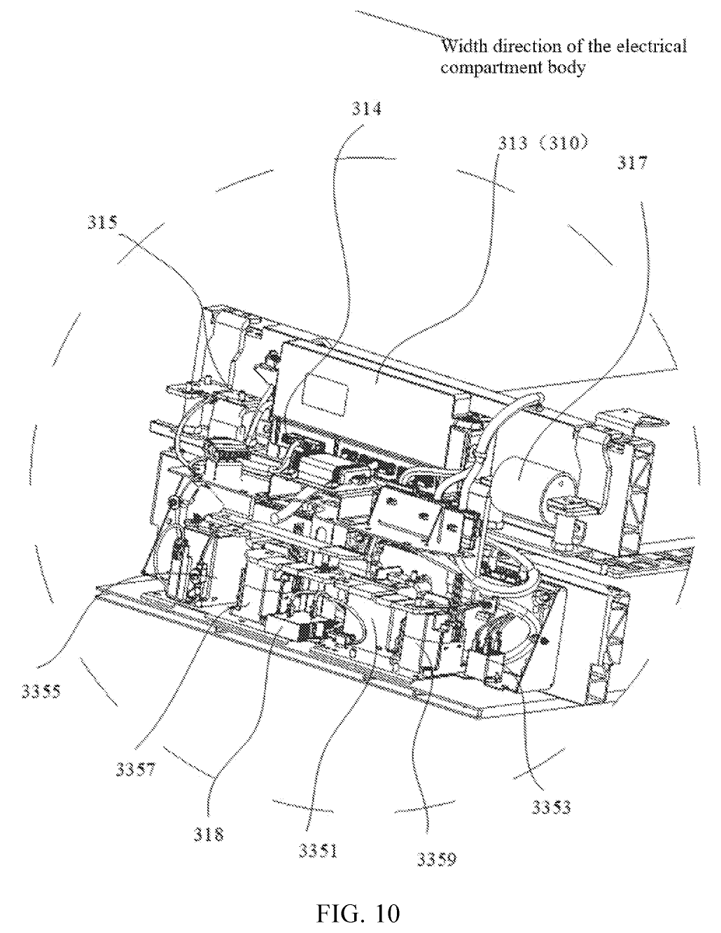

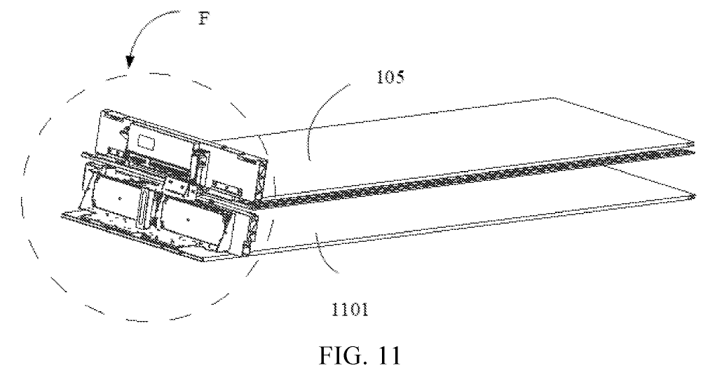

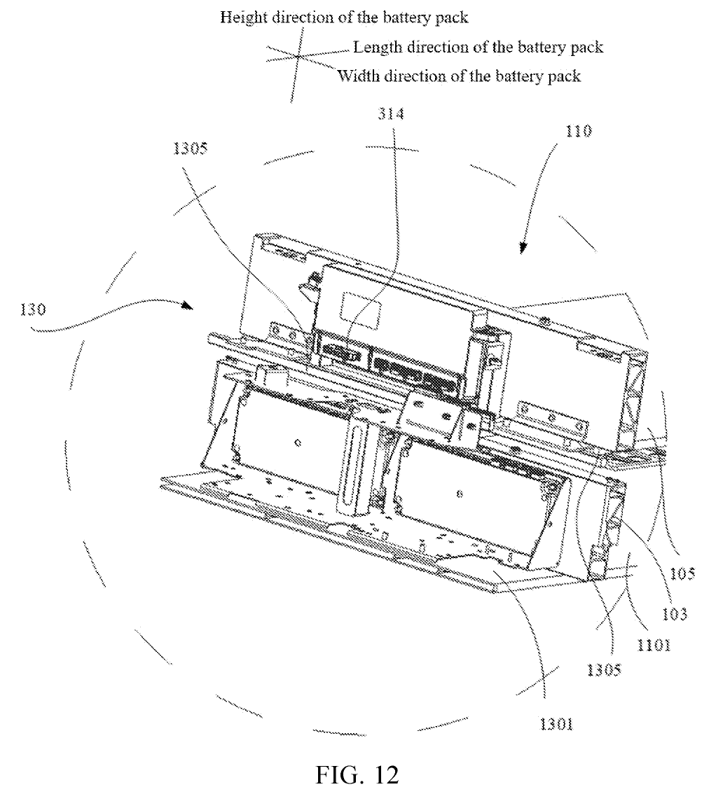

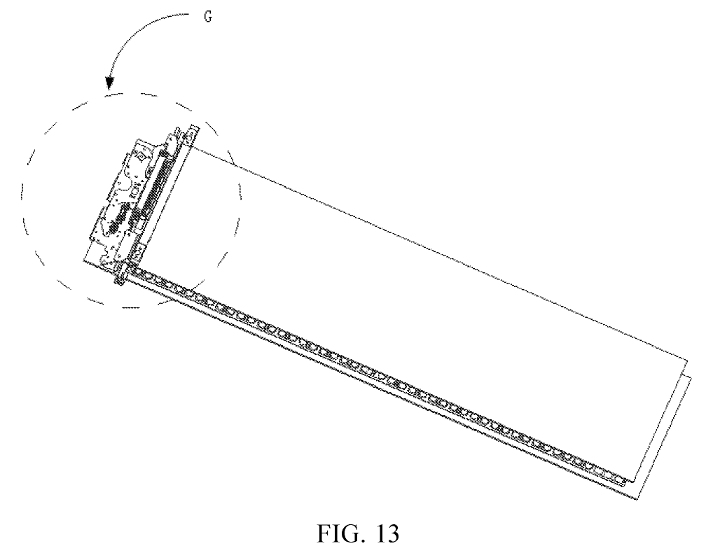

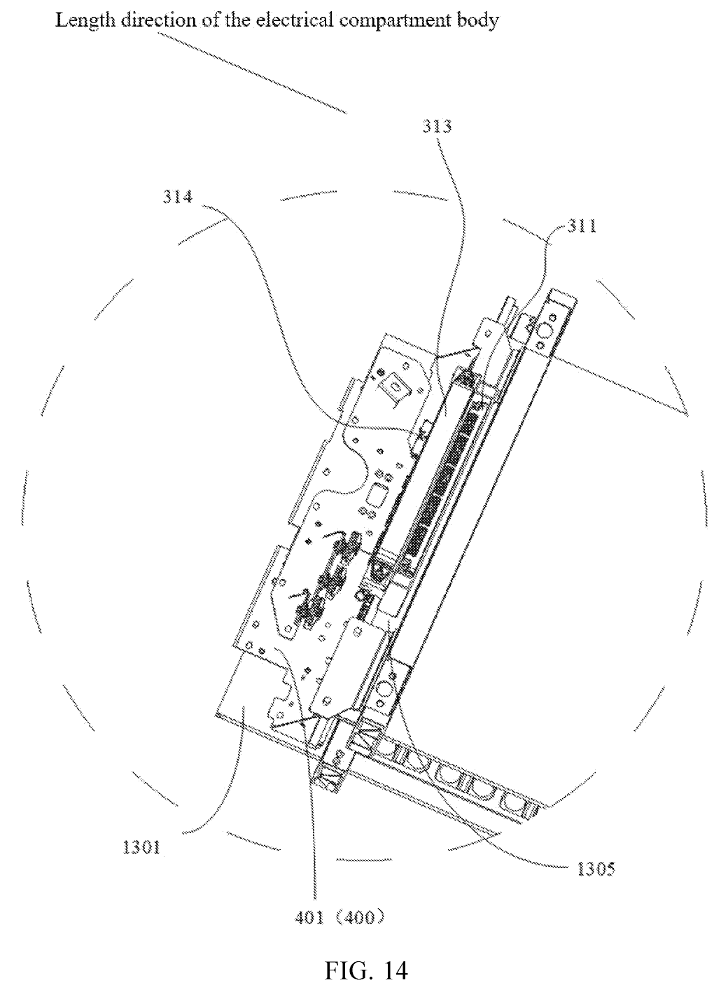

Please combine with FIGS. 9, 10, 11, 12, 13, and 14, in some embodiments, the battery compartment body 110 includes a second bottom wall 1101 and a middle housing 105 arranged along the height direction of the battery pack (or the height direction of the electrical compartment body). The battery module 200 includes a first battery module 210 and a second battery module 230. The first battery module 210 is installed on the side of the middle housing 105 facing away from the second bottom wall 1101, and the second battery module 230 is installed between the middle housing 105 and the second bottom wall 1101.

Referring to FIG. 3, in some embodiments, the middle housing 105 may be connected to the mounting housing 109 via welding, bolting, or snap-fitting. The middle housing 105 divides the internal space of the battery compartment body 110 into a first cavity 111 and a second cavity 113 arranged along the vehicle’s height direction. In some examples, the battery compartment body 110 further includes a battery compartment cover 102, with the first cavity 111 located between the middle housing 105 and the battery compartment cover 102, and the second cavity 113 located on the side of the middle housing 105 facing away from the battery compartment cover 102.

In some embodiments, the battery compartment cover 102 and an electrical compartment cover 1307 may be parts of a single cover, and the second bottom wall 1101 and the first bottom wall 1301 may be parts of a single bottom wall.

The battery module 200 includes the first battery module 210 and the second battery module 230. The first battery module 210 is installed in the first cavity 111, and the second battery module 230 is installed in the second cavity 113.

In these embodiments, arranging the first battery module 210 and the second battery module 230 along the vehicle’s height direction in the first cavity 111 and the second cavity 113, respectively, results in a double-layer housing structure for the battery pack 10. The internal space of the battery compartment body 110 is divided into the first cavity 111 and the second cavity 113 along the vehicle’s height direction, saving horizontal space. This reduces the overall horizontal footprint of the battery pack, allowing more space for battery modules, increasing the number of cells, and improving the battery pack’s driving range.

The middle housing 105 may include a battery module tray for the first battery module 210, providing impact resistance, vibration resistance, and protection.

In some embodiments, the first battery module 210 and the second battery module 230 may be connected in series.

In some embodiments, additional battery modules, such as a third battery module 240 and a fourth battery module 250, may be included. The third battery module 240 is arranged along the length direction of the vehicle with respect to the first battery module 210, with a crossbeam optionally disposed therebetween. The fourth battery module 250 is arranged along the length direction of the vehicle with respect to the second battery module 230, with a crossbeam optionally disposed therebetween. The third battery module 240 and the fourth battery module 250 are arranged along the vehicle’s height direction. The first battery module 210, the second battery module 230, the third battery module 240, and the fourth battery module 250 are connected in series, enabling higher capacity, voltage, and current.

In some embodiments, the first mounting member 1305 is connected to the middle housing 105 via bolting, snap-fitting, bonding, or welding.

In other embodiments, the first mounting member 1305 may be plate-shaped, extending along the length direction of the battery pack. The first mounting member 1305 may be integrally formed with the middle housing 105.

In some embodiments, the second bottom wall 1101 is located on the side of the middle housing 105 facing away from the battery compartment cover 102, with the second cavity 113 located between the middle housing 105 and the second bottom wall 1101. The second bottom wall 1101 may serve as a battery module tray for the second battery module 230, protecting the second battery module 230 from impact and vibration.

In some embodiments, the battery pack further includes a crossbeam 103, at least part of which is disposed between the battery compartment body 110 and the electrical compartment body 130.

In some examples, the housing assembly 100 may include a housing 101 and the crossbeam 103, with the housing 101 defining an installation cavity. The crossbeam 103 is connected to the housing 101, forming the battery compartment body 110 and the electrical compartment body 130 arranged along the vehicle’s length direction.

The housing 101 may be formed by stamping to create the installation cavity or by connecting different parts of the housing 101. The crossbeam 103 may be connected to the housing 101 via bolting, welding, or snap-fitting. The housing 101 may include a mounting housing and a cover, defining the installation cavity. The crossbeam 103 may be connected to the mounting housing 109 via welding, bolting, or snap-fitting.

In these embodiments, the crossbeam 103 may serve as an expansion beam for the battery pack 10. The mounting housing 109 may include a battery tray and other structures for mounting the battery module. The crossbeam 103 may directly or indirectly contact the battery module 200, providing support and protection during volume changes due to charging or discharging.

The crossbeam between the battery compartment body 110 and the electrical compartment body 130 accommodates volume expansion of battery cells during charging and discharging due to temperature changes. Additionally, the crossbeam enhances the structural strength of the battery pack and provides additional protection during side collisions.

In some embodiments, the second mounting portion 403 is spaced apart from the crossbeam 103 to prevent the expansion of the battery module in the battery compartment body 110 from compressing the second BMS unit 330.

In some embodiments, an elastic member, such as foam, may be placed between the second mounting member 400 and the crossbeam 103 to mitigate the effects of battery module expansion.

In some embodiments, the electrical compartment body 130 further includes an electrical compartment cover 1307 and a first sidewall 1308 connected to the first bottom wall 1301. The electrical compartment cover 1307 is connected to the first sidewall 1308. The first BMS 313 includes a wiring portion 314 located at an end of the first BMS 313 away from the electrical compartment cover 1307. This allows a wiring harness to connect to the wiring portion 314 from the end away from the electrical compartment cover 1307 and thereby connect to the first BMS 313 through the wiring portion 314. This avoids interference with the electrical compartment cover 1307.

The first sidewall 1308 and the first bottom wall 1301 may be connected via welding, bonding, or integral molding. The electrical compartment cover 1307 and the first sidewall 1308 may be detachably connected, e.g., via bolting or snap-fitting.

The first BMS 313 includes the wiring portion 314 at the end away from the electrical compartment cover 1307. This allows the wiring harness to connect to the wiring portion 314 from the end away from the electrical compartment cover 1307 and then connect to the first BMS 313 through the wiring portion 314. This avoids interference with the electrical compartment cover 1307. One end of the wiring harness may be electrically connected to the first BMS 313 via the wiring portion 314, while the other end of the wiring harness connects to electrical components in the electrical compartment, enabling the first BMS 313 to collect current and voltage data from these electrical components and manage their operational states.

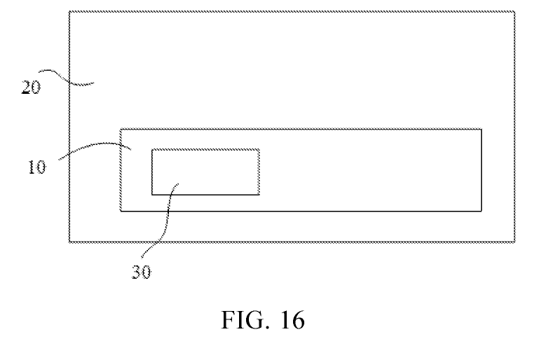

In a third aspect, referring to FIG. 16, embodiments of the present application further provide a vehicle 20 including the battery pack 10.

What is claimed is:

1. An electrical compartment for a battery pack, comprising:
an electrical compartment body; and
a battery management system (BMS) assembly installed within the electrical compartment body and configured to connect to a battery module, the BMS assembly comprising a first BMS unit and a second BMS unit, wherein the first BMS unit and the second BMS unit are arranged along a height direction of the electrical compartment body.

2. The electrical compartment according to claim 1, wherein the electrical compartment body comprises a first bottom wall and a first mounting member arranged opposite each other along the height direction of the electrical compartment body, the first BMS unit is disposed on a side of the first mounting member facing away from the first bottom wall, and the second BMS unit is installed between the first bottom wall and the first mounting member.

3. The electrical compartment according to claim 2, wherein the first BMS unit comprises a first BMS and a second BMS arranged along a length direction of the electrical compartment body, the first BMS is electrically connected to the second BMS, and the second BMS is configured to electrically connect to a battery module.

4. The electrical compartment according to claim 2, further comprising a first overcurrent assembly configured to electrically connect to a battery module, wherein the first overcurrent assembly is installed on the side of the first mounting member facing away from the first bottom wall and is arranged along a width direction of the electrical compartment body with respect to the first BMS unit.

5. The electrical compartment according to claim 4, wherein the first overcurrent assembly comprises a shunt configured to electrically connect to the battery module and arranged along the width direction of the electrical compartment body with respect to the first BMS unit.

6. The electrical compartment according to claim 5, wherein the first overcurrent assembly further comprises a first fuse, and along the width direction of the electrical compartment body, the first BMS unit is positioned between the shunt and the first fuse.

7. The electrical compartment according to claim 6, wherein the electrical compartment body further comprises a second mounting member disposed between the first bottom wall and the first mounting member;
the second mounting member comprises a first mounting portion installed on the first bottom wall and arranged opposite to the first bottom wall; and
the electrical compartment further comprises a second overcurrent assembly installed on a side of the first mounting portion facing away from the first bottom wall, the second overcurrent assembly being electrically connected to the first overcurrent assembly.

8. The electrical compartment according to claim 7, wherein the second overcurrent assembly comprises:
a charging positive relay electrically connected to the first fuse; and a charging negative relay electrically connected to the shunt, wherein the charging positive relay and the charging negative relay are arranged along the width direction of the electrical compartment body.

9. The electrical compartment according to claim 8, wherein the second overcurrent assembly further comprises a first positive relay and a first negative relay, the first positive relay is electrically connected to the first fuse, and the first negative relay is electrically connected to the shunt, wherein the first positive relay is positioned between the charging positive relay and the charging negative relay, and the first negative relay is positioned on a side of the charging negative relay facing away from the charging positive relay.

10. The electrical compartment according to claim 9, wherein the second overcurrent assembly further comprises a pre-charge resistor electrically connected to the first fuse and disposed between the first positive relay and the charging negative relay.

11. The electrical compartment according to claim 10, wherein the second overcurrent assembly further comprises a pre-charge relay disposed on a side of the charging positive relay facing away from the charging negative relay and electrically connected to the pre-charge resistor.

12. The electrical compartment according to claim 7, wherein the second mounting member further comprises a second mounting portion connected via a bent connection to the first mounting portion ; at least part of the second mounting portion is located between the first mounting portion and the first mounting member, the second BMS unit is installed on a side of the second mounting portion adjacent to the second overcurrent assembly, and the second BMS unit and the second overcurrent assembly are arranged along the length direction of the electrical compartment body.

13. The electrical compartment according to claim 12, wherein the second BMS unit comprises a third BMS and a fourth BMS, and the third BMS and the fourth BMS are arranged along the width direction of the electrical compartment body, wherein the second mounting member further comprises a reinforcement portion, at least part of which is located between the first mounting portion and the second mounting portion, the reinforcement portion is connected to the first mounting portion and the second mounting portion.

14. A battery pack for a vehicle, comprising:
a battery compartment body;
a battery module installed in the battery compartment body; and
the electrical compartment according to claim 1, wherein the electrical compartment body is connected to the battery compartment body, and the battery compartment body and the electrical compartment body are arranged along a length direction of the battery pack.

15. The battery pack according to claim 14, wherein the battery compartment body comprises a second bottom wall and a middle housing, the second bottom wall and the middle housing are arranged along a height direction of the battery pack, the battery module comprises a first battery module and a second battery module, the first battery module is installed on a side of the middle housing facing away from the second bottom wall, and the second battery module is installed between the middle housing and the second bottom wall.

16. The battery pack according to claim 15, wherein the electrical compartment body comprises a first bottom wall and a first mounting member arranged opposite each other along the height direction of the battery pack, and the first mounting member is connected to the middle housing.

17. The battery pack according to claim 14, further comprising a crossbeam, wherein at least part of the crossbeam is disposed between the battery compartment body and the electrical compartment body.

18. The battery pack according to claim 17, wherein at least part of the crossbeam is spaced apart from a second mounting portion.

19. The battery pack according to claim 16, wherein the first BMS unit comprises a first BMS and a second BMS, the electrical compartment body further comprises an electrical compartment cover and a first sidewall, the first sidewall is connected to the first bottom wall, the electrical compartment cover is connected to the first sidewall, and the first BMS comprises a wiring portion located at an end of the first BMS away from the electrical compartment cover.

20. A vehicle, comprising a battery pack for a vehicle, the battery pack comprising:
a battery compartment body;
a battery module installed in the battery compartment body; and
the electrical compartment according to claim 1, wherein the electrical compartment body is connected to the battery compartment body, and the battery compartment body and the electrical compartment body are arranged along a length direction of the battery pack.
